(19) United States
(12) Patent Application Publication
(10) Pub. No.: US 2005/0233217 A1
(43) Pub. Date: Oct. 20, 2005

(54) Nonaqueous electrolyte secondary battery

(76) Inventors: Toyoki Fujihara, Hyogo (JP); Akira Kinoshita, Hyogo (JP); Shingo Tode, Hyogo (JP); Hiroyuki Fujimoto, Hyogo (JP); Yasufumi Takahashi, Hyogo (JP); Ikuro Nakane, Hyogo (JP); Shin Fujitani, Hyogo (JP)

Correspondence Address: Kubovcik & Kubovcik;The Farragut Building, Suite 710, 900 17th Street NW, Washington, DC, 20006, US

(21) Appl. No.: 10/522,771

(22) PCT Filed: Oct. 30, 2003
(86) PCT No.: PCT/JP03/13907

§ 371 Date: Jan. 28, 2005

(30) Foreign Application Priority Data
Nov. 1, 2002 (JP) 2002-320162

(51) Int. Cl. H01M 4/50; H01M 4/52; H01M 10/52; H01M 2/02

(52) U.S. Cl. 429/231.1; 429/223; 429/224; 429/176; 429/231.3; 429/59

(57) ABSTRACT

A sealed nonaqueous electrolyte secondary battery having a case which is deformed when the inner pressure is increased is characterized in that a material capable of occluding and releasing lithium is used as a negative electrode material, and a mixture of a lithium transition metal composite oxide containing Ni and Mn as transition metals and having a layered structure and a lithium cobaltate is used as a positive electrode material.

### TECHNICAL FIELD

The present invention relates to a nonaqueous electrolyte secondary battery. More specifically, this invention relates to a nonaqueous electrolyte secondary battery wherein a lithium transition metal complex oxide containing Ni and Mn is used as a positive electrode material.

### BACKGROUND ART

In recent years, a nonaqueous electrolyte secondary battery which uses a carbon material, metallic lithium or a material capable of alloying with lithium as the negative electrode material and a lithium transition metal complex oxide represented by LiMO₂ (M is a transition metal) as the positive electrode material has been noted as a high energy-density secondary battery.

A typical example of the lithium transition metal complex oxide is a lithium cobalt complex oxide (lithium cobaltate:LiCoO₂). This complex oxide has been already put into practice as the positive electrode active material of a nonaqueous electrolyte secondary battery.

However, lithium transition metal oxides containing Ni or Mn as a transition metal have been also studied for their use as the positive electrode active material. For example, materials containing all of the transition metals Co, Ni and Mn have been extensively studied (See, for example, Japanese Patent Nos. 2,561,556 and 3,244,314 and Journal of Power Sources 90 (2000) 176-181).

Among those lithium transition metal complex oxides containing Co, Ni and Mn, a material containing Ni and Mn in the same percentage composition, i.e., represented by the formula LiMnₓNiₓCo₍₁₋₂ₓ₎O₂, is reported to show, even in the charged state (highly oxidized state), remarkably high thermal stability (Electrochemical and Solid-State Letters, 4(12) A200-A203 (2001)).

The above-described complex oxide containing Ni and Mn in substantially the same percentage composition is also reported to show a voltage around 4 V, as comparable to LiCoO₂, a large capacity and a superior charge-discharge efficiency (Japanese Patent Laying-Open No. 2002-42813). Therefore, when a lithium transition metal complex oxide containing Co, Ni and Mn and having a layered structure (e.g., represented by the formula LiₐMn_{b}Ni_{b}Co_{(1-2b)}O₂ (0≦a≦1.2, 0<b≦0.5)) is used as the positive electrode material of a battery, the battery is expected to achieve a marked reliability improvement because of its high thermal stability during charge.

As will be described later, the present invention also uses a mixture of the aforesaid lithium transition metal complex oxide and lithium cobaltate as the positive electrode material. The use of such a mixture as the positive electrode material of a coin-type cell is disclosed in the art (Japanese Patent Laying-Open No. 2002-100357).

The inventors of this application have studied performance characteristics of a lithium secondary battery using the aforesaid lithium transition metal complex oxide containing Co, Ni and Mn as the positive electrode active material, and as the result, have found that when the battery is stored in the charged state at high temperature exceeding a service condition as of a portable telephone actually used in a car, which is estimated as being 80° C., a gas is generated, due likely to a reaction between the positive electrode and the electrolyte solution, to expand the battery having the configuration for use in the portable telephone or the like. For example, batteries using a thin-wall aluminum alloy can or a laminated aluminum film as the outer casing have been found to show large expansion and significant deterioration, e.g., marked reduction of a battery capacity, when they are stored.

### DISCLOSURE OF THE INVENTION

It is an object of the present invention to provide a nonaqueous electrolyte secondary battery which uses the lithium transition metal complex oxide, as described above, as the positive electrode material and which, when stored in the charged state under the high temperature condition, can reduce gas evolution to the extent that prevents expansion and improve high-temperature storage characteristics thereof.

The present invention provides a sealed, nonaqueous electrolyte secondary battery having an outer casing which deforms as an internal pressure of the battery increases. Characteristically, the battery uses a material capable of storing and releasing lithium as the negative electrode material, and a mixture containing a lithium transition metal complex oxide and lithium cobaltate as the positive electrode material. The lithium transition metal complex oxide contains Ni and Mn as transition metals and also has a layered structure.

Mixing lithium cobaltate in the lithium transition metal complex oxide, in accordance with this invention, reduces a gas generated in the battery while stored in the charged state at high temperature and accordingly prevents expansion of the battery and improves its high-temperature storage properties. Japanese Patent Laying-Open No. 2002-100357 discloses a lithium secondary battery which uses a mixture of a lithium transition metal complex oxide and lithium cobaltate as the positive electrode material. However, this reference does not disclose that incorporation of lithium cobaltate reduces a gas generated in the battery while stored in the charged state at high temperatures. Also, in the embodiment described in Japanese Patent Laying-Open No. 2002-100357, a coin cell construction is shown. No disclosure is provided as to the use of an outer casing which deforms in an expanding fashion when an internal pressure increases.

In the present invention, a gas generated during battery storage increases an internal pressure of the battery. It is believed that the gas is generated during storage by a reaction between the lithium transition metal complex oxide and the electrolyte solution, as illustrated by the below-described Reference Example.

In the case where the positive and negative electrodes both have rectangular electrode surfaces and the nonaqueous electrolyte secondary battery has a rectangular shape, a gas generated during storage of the battery shows a tendency to reside between the electrodes.

The nonaqueous electrolyte secondary battery according to another aspect of the present invention has a rectangular shape and includes positive and negative electrodes each having a rectangular electrode face. Characteristically, the battery uses a material capable of storing and releasing lithium as the negative electrode material, and a mixture containing a lithium transition metal complex oxide and lithium cobaltate as the positive electrode material. The lithium transition metal complex oxide contains Ni and Mn as transition metals and also has a layered structure.

The positive and negative electrodes may be assembled in a manner to provide a rectangular electrode face. For example, the opposing positive and negative electrodes may be rolled up with a separator between them into a flat shape. The opposing positive and negative electrodes with a separator between them may be folded into a rectangular shape. Alternatively, the positive and negative electrodes each having a rectangular shape may be layered with a separator interposed between them.

The nonaqueous electrolyte secondary battery according a further aspect of this invention is a sealed, nonaqueous electrolyte secondary battery which uses, as its positive electrode material, a lithium transition metal complex oxide containing Ni and Mn as transition metals and having a layered structure, and has an outer casing which deforms in an expanding fashion, responsive to a gas generated during storage of the battery when only the lithium transition metal complex oxide is used as the positive electrode material. Characteristically, the battery uses a mixture of the lithium transition metal complex oxide and lithium cobaltate as the positive electrode material.

In the present invention, the outer casing which deforms when an internal pressure increases may be formed at least partly of an aluminum alloy or laminated aluminum film with a thickness of 0.5 mm or below, for example. In the present invention, the laminated aluminum film refers to a layered film having plastic films laminated on opposite surfaces of an aluminum foil. Typical examples of such plastic films are polypropylene and polyethylene films. Also, at least a portion of the outer casing may be formed of an iron alloy having a thickness of 0.3 mm or below. When an internal pressure of the battery increases, the outer casing such designed deforms in a manner to expand at a portion formed of the above-described material.

In the present invention, the lithium transition metal complex oxide is preferably the one represented by the formula LiₐMnₓNi_{y}Co_{z}O₂ (wherein a, x, y and z are numerical values which satisfy the relationships 0≦a≦1.2, x+y+z=1, x>0, y>0, and z≧0). More preferably, nickel and manganese are contained in substantially the same amount, i.e., x and y in the formula have substantially the same value. In the lithium transition metal complex oxide, nickel has a nature of large capacity and low thermal stability during charge, and manganese has a nature of low capacity and high thermal stability during charge. Accordingly, nickel and manganese are preferably contained in substantially the same amount to best balance the respective natures of nickel and manganese.

In the above formula, x, y and z more preferably fall within the following ranges; 0.25≦x≦0.5, 0.25≦y≦0.5 and 0≦z≦0.5.

The more uniform mixture of the lithium transition metal complex oxide and lithium cobaltate is believed to prevent expansion and storage deterioration of the battery more effectively. It is accordingly preferred that the lithium transition metal complex oxide and lithium cobaltate both have small particle diameters. Specifically, the lithium cobaltate preferably has a mean particle diameter of 10 μm or smaller and the lithium transition metal complex oxide preferably has a mean particle diameter of 20 μm or smaller. Their mean particle diameters can be measured by a laser diffraction particle-size distribution measurement device.

Also in the present invention, the lithium transition metal complex oxide and lithium cobaltate are preferably mixed together before they are mixed with a binder to form a slurry or a positive electrode mix.

In the present invention, the lithium transition metal complex oxide and lithium cobaltate are blended preferably in the proportion by weight (lithium transition metal complex oxide:lithium cobaltate) of 4:6-9.5:0.5, more preferably 5:5-8:2.

In a further aspect of the present invention, a method is provided for reducing a gas generated when a nonaqueous electrolyte secondary battery using the lithium transition metal complex oxide as the positive electrode material is stored in the charged state. Characteristically, lithium cobaltate is mixed in the lithium transition metal complex oxide.

The mechanism by which a large amount of gas evolves when a nonaqueous electrolyte secondary battery using a lithium transition metal complex oxide as the positive electrode material is stored in the charged state at high temperatures is not clear at the present time. Accordingly, the details of why mixing of lithium cobaltate is effective to reduce gas generation are not clear, either. It is however assumed that the catalytic surface activity of the lithium transition metal complex oxide is reduced by contact with the lithium cobaltate mixed therein. It is also assumed that the incorporated lithium cobaltate either traps or hinders production of a precursor, e.g., HF produced when an electrolyte solution decomposes.

In the present invention, it is more preferred that the lithium transition metal complex oxide contains fluorine. Inclusion of fluorine in the lithium transition metal complex oxide further reduces a gas generated in the secondary battery while stored in the charged state at high temperatures and as a result, further reduces battery expansion and further improves high-temperature storage properties of the battery.

A fluorine content of the lithium transition metal complex oxide is preferably between 100 ppm and 20,000 ppm. If the fluorine content is excessively low, the effect of reducing gas generation may not be offered sufficiently. On the other hand, the excessively high fluorine content may adversely affect discharge characteristics of the positive electrode.

There are various methods by which fluorine is contained in the lithium transition metal complex oxide. According to one exemplary method, a fluorine compound is added to a raw material while formulated to provide the lithium transition metal complex oxide. Such a fluorine compound is illustrated by LiF.

The amount of fluorine present in the lithium transition metal complex oxide can be measured as by an ion meter.

The details of why inclusion of fluorine is effective to reduce gas generation are not clear. It is assumed that when the battery is charged, the positive electrode material is oxidized to shift the transition metal (Ni or Mn) to a higher oxidation state and this transition metal catalytically acts on a surface of the active material to generate a gas, and that fluorine, if then included in the positive active electrode material, causes a change in oxidation state of the transition metal to thereby reduce gas generation.

In the present invention, any material can be used for the negative electrode so long as it can store and release lithium and is generally useful for the negative electrode of nonaqueous electrolyte secondary batteries. Useful examples include graphite materials, metallic lithium and lithium-alloying materials. Examples of lithium-alloying materials include silicon, tin, germanium and aluminum.

Any electrolyte known as useful for a lithium secondary battery and other nonaqueous electrolyte secondary batteries can be used for the nonaqueous electrolyte secondary battery of the present invention. An electrolyte solvent is not particularly specified in type, and can be illustrated by a mixed solvent containing cyclic carbonate and chain carbonate. Examples of cyclic carbonates include ethylene carbonate, propylene carbonate, butylene carbonate and vinylene carbonate. Examples of chain carbonates include dimethyl carbonate, methyl ethyl carbonate and diethyl carbonate. Any of the above-listed cyclic carbonate, in combination with an ether solvent such as 1,2-dimethoxyethane or 1,2-diethoxyethane, also provides a useful mixed solvent.

The electrolyte solute is not particularly specified in type. Examples of electrolyte solutes include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀ and Li₂B₁₂Cl₁₂ and their mixtures.

### BRIEF DESCRIPTION OF THE DRAWINGS

FIG. 1 is a plan view which shows the lithium secondary battery constructed in accordance with one embodiment of the present invention;

FIG. 2 is a view which shows the condition of the negative electrode (top side) of the battery of Example 1 in accordance with the present invention when charged after the storage test;

FIG. 3 is a view which shows the condition of the negative electrode (back side) of the battery of Example 1 in accordance with the present invention when charged after the storage test;

FIG. 4 is a view which shows the condition of the negative electrode (top side) of the battery of Comparative Example 2 when charged after the storage test;

FIG. 5 is a view which shows the condition of the negative electrode (back side) of the battery of Comparative Example 2 when charged after the storage test;

FIG. 6 is a view which shows the condition of the battery of Comparative Example 2 before the storage test;

FIG. 7 is a view which shows the condition of the battery of Comparative Example 2 after the storage test;

FIG. 8 is a schematic sectional view which shows the three-electrode beaker cell;

FIG. 9 is a chart which shows an XRD pattern of the positive electrode of the battery of Comparative Example 2 before the storage test; and

FIG. 10 is a chart which shows an XRD pattern of the positive electrode of the battery of Comparative Example 2 after the storage test.

### BEST MODE FOR CARRYING OUT THE INVENTION

The present invention is below described in more detail by way of Examples. It will be recognized that the following examples merely illustrate the practice of the present invention but are not intended to be limiting thereof. Suitable changes and modifications can be effected without departing from the scope of the present invention.

Experiment 1

### EXAMPLE 1

Preparation of LiMn_{0.33}Ni_{0.33}Co_{0.34}O₂)

LIOH and a coprecipitated hydroxide, represented by Mn_{0.33}Ni_{0.33}Co_{0.34}(OH)₂, were mixed in an Ishikawa automated mortar such that a molar ratio of Li to all transition metals was brought to 1:1, and then heat treated in an ambient atmosphere at 1,000° C. for 20 hours. After the heat treatment, the resultant was ground to obtain a lithium transition metal complex oxide having a mean particle diameter of about 5 μm and represented by LiMn_{0.33}Ni_{0.33}Co_{0.34}O₂.

(Preparation of Lithium Cobaltate (LiCoO₂))

LiOH and Co(OH)₂ were mixed in an Ishikawa automated mortar such that a molar ratio of Li to Co was brought to 1:1, and then heat treated in an ambient atmosphere at 1,000° C. for 20 hours. After the heat treatment, the resultant was ground to obtain LiCoO₂ with a mean particle diameter of about 5 μm.

(Fabrication of Positive Electrode)

The above-obtained LiMn_{0.33}Ni_{0.33}Co_{0.34}O₂ and LiCoO₂ in the weight ratio of 1:1 were mixed in an Ishikawa automated mortar to obtain a positive active material. This positive active material, carbon as an electroconductive agent and vinylidene polyfluoride as a binder in the weight ratio (active material:conductive agent:binder) of 90:5:5 were mixed, added to N-methyl-2-pyrrolidone as a dispersing medium, and then kneaded to prepare a positive electrode slurry. The prepared slurry was coated onto an aluminum foil as a current collector, dried and then calendered using a calender roll. The subsequent attachment of a current collecting tab resulted in the fabrication of a positive electrode.

(Fabrication of Negative Electrode)

Artificial graphite as a negative active material and styrene-butylene rubber as a binder were added to an aqueous solution of carboxymethylcellulose as a thickener such that the proportion by weight of the active material, binder and thickener was brought to 95:3:2. The resulting mixture was kneaded to prepared a negative electrode slurry. The prepared slurry was coated onto a copper foil as a current collector, dried and then calendered using a calender roll. The subsequent attachment of a current collecting tab resulted in the fabrication of a negative electrode.

(Preparation of Electrolyte Solution)

1 mole/liter of LiPF₆ was dissolved in a mixed solvent containing ethylene carbonate (EC) and ethyl methyl carbonate (EMC) at a 3:7 ratio by volume to prepare an electrolyte solution.

(Construction of Battery)

The above-fabricated positive and negative electrodes were assembled in a manner to interpose a separator, rolled up and then pressed flat to provide a group of electrodes. In a glove box under argon atmosphere, this group of electrodes was inserted into a 0.11 mm thick, aluminum laminate outer casing. After introduction of the electrolyte solution, the outer casing was sealed.

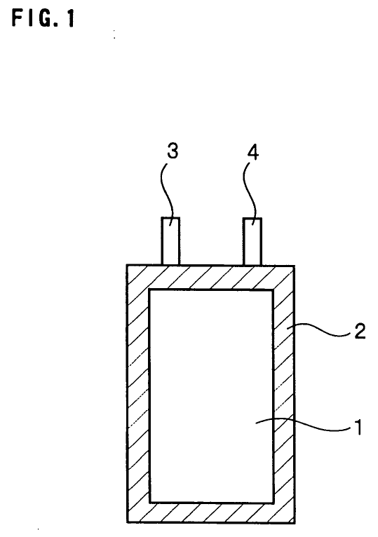

FIG. 1 is a plan view, illustrating the constructed lithium secondary battery A1. In the lithium secondary battery, the aluminum laminate outer casing 1 is heat sealed at outer edges to form a sealed portion 2. A positive current collecting tab 3 and a negative current collecting tab 4 extend upwardly from the outer casing 1. The battery was built in a 3.6 mm thick, 3.5 cm wide and 6.2 cm long size. The constructed battery had an initial thickness of 3.74 mm.

### EXAMPLE 2

The procedure used to fabricate the positive electrode in Example 1 was followed, except that LiMn_{0.33}Ni_{0.33}Co_{0.34}O₂ and LiCoO₂ in the weight ratio of 7:3 were mixed, to construct a lithium secondary battery A2. The constructed battery had an initial thickness of 3.68 mm.

### COMPARATIVE EXAMPLE 1

The procedure of Example 1 was followed, except that LiMn_{0.33}Ni_{0.33}Co_{0.34}O₂ was excluded and only LiCoO₂ was used as the positive active material, to construct a lithium secondary battery X1. The constructed battery had an initial thickness of 3.67 mm.

### COMPARATIVE EXAMPLE 2

The procedure of Example 1 was followed, except that LiCoO₂ was excluded and only LiMn_{0.33}Ni_{0.33}Co_{0.34}O₂ was used as the positive active material, to construct a lithium secondary battery X2. The constructed battery had an initial thickness of 3.80 mm.

(Evaluation of High-Temperature Storage Properties)

Each of the constructed lithium secondary batteries A1, A2, X1 and X2 was charged at room temperature at a constant current of 650 mA to a voltage of 4.2 V, further charged at a constant voltage of 4.2 V to a current value of 32 mA, and then discharged at a constant current of 650 mA to a voltage of 2.75 V to thereby measure a discharge capacity (mAh) of the battery before storage.

Next, the battery was charged at room temperature at a constant current of 650 mA to a voltage of 4.2 V, further charged at a constant voltage of 4.2 V to a current value of 32 mA, and then stored in a constant temperature bath at 85° C. for 3 hours. The battery after storage was cooled at room temperature for 1 hour and then measured for battery thickness. The measured thickness was compared to the initial thickness to determine a thickness increment (mm) and a percentage (%) of increase, which were evaluated as an expansion of each battery after storage. The battery expansion evaluation result for each battery after storage are shown in Table 1. The value written in each bracket ( ) for battery expansion represents a battery expansion rate (=thickness increment/initial thickness×100). Also, the estimated values are battery expansion values estimated for the batteries A1 and A2, based on their respective lithium transition metal complex oxide contents, from the actually measured battery expansion values for the battery X1 having a lithium transition metal complex oxide content of 0% and the battery X2 having a lithium transition metal complex oxide content of 100%.

TABLE 1

| | | LiMn_{0.33}Ni_{0.33}Co_{0.34}O₂ | Battery Expansion after | |
|---|---|---|---|---|
| | | Content of Positive | High-Temperature Storage | |
| | | Active Material | Measured | Estimated |
| | Battery | (parts by weight) | Value (mm) | Value (mm) |
| Comp. | X1 | 0 | 0.18 (4.9%) | 0.18 (4.9%) |
| Ex. 1 | | | | |
| Ex. 1 | A1 | 50 | 0.85 (22.7%) | 1.52 (40.6%) |
| Ex. 2 | A2 | 70 | 1.69 (45.9%) | 2.05 (55.7%) |
| Comp. | X2 | 100 | 2.85 (75.0%) | 2.85 (75.0%) |
| Ex. 2 | | | | |

As can be clearly seen from the results shown in Table 1, the measured expansion values after high-temperature storage are lower than the estimated expansion values, for the batteries A1 and A2 of Examples 1 and 2 where lithium cobaltate was mixed in the lithium transition metal complex oxide. That is, it is demonstrated that the mixing of lithium cobaltate in the lithium transition metal complex oxide renders the measured expansion values for those two batteries lower than the values estimated from their respective lithium transition metal complex oxide contents, thus reducing expansion of the batteries after high-temperature storage.

Next, each battery after storage was discharged at room temperature at a constant current of 650 mA to a voltage of 2.75 V to measure a retained capacity (mAh). The retained capacity was divided by the discharge capacity before storage to give a retention rate.

After measurement of the retained capacity, the battery was charged at a constant current of 650 mA to a voltage of 4.2 V, further charged at a constant voltage of 4.2 V to a current value of 32 mA, and then discharged at a constant current of 650 mA to a voltage of 2.75 V to measure a restored capacity. The restored capacity was divided by the discharge capacity before storage to give a restoration rate.

The discharge capacity before storage, retained capacity, retention rate, restored capacity and restoration rate, as measured according to the above-described procedures, for each battery are listed in Table 2.

TABLE 2

| | | | | Retained | Restored |
|---|---|---|---|---|---|
| | | LiMn_{0.33}Ni_{0.33}Co_{0.34}O₂ | Discharged | Capacity | Capacity |
| | | Content of Positive | Capacity | (mAh) | (mAh) |
| | | Active Material | before | (Retention | (Restoration |
| | Battery | (parts by weight) | Storage (mAh) | Rate) | Rate) |
| Comp. | X1 | 0 | 652.2 | 602.0 | 619.5 |
| Ex. 1 | | | | (92.3%) | (95.0%) |
| Ex. 1 | A1 | 50 | 660.6 | 609.1 | 626.8 |
| | | | | (92.2%) | (94.9%) |
| Ex. 2 | A2 | 70 | 690.2 | 579.8 | 599.8 |
| | | | | (84.0%) | (86.9%) |
| Comp. | X2 | 100 | 673.0 | 483.8 | 506.3 |
| Ex. 2 | | | | (71.9%) | (75.2%) |

As can be apparent from Table 2, the battery A1 of Example 1 exhibits retention and restoration rates which are comparable to those of the battery X1 of Comparative Example 1. This clearly demonstrates that mixing of lithium cobaltate in the lithium transition metal complex oxide, in accordance with the present invention, results in the improved high-temperature storage properties.

(Condition Observation of Negative Electrode After Storage Test)

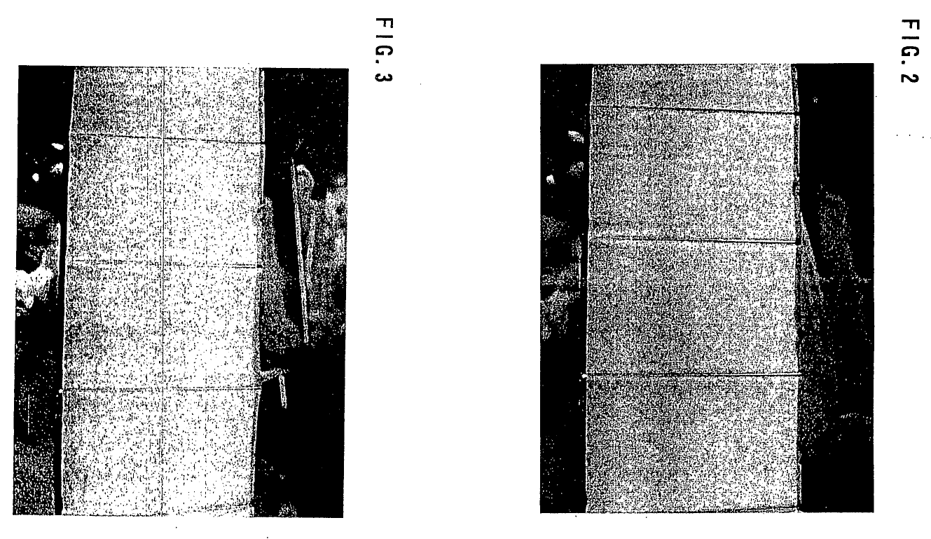

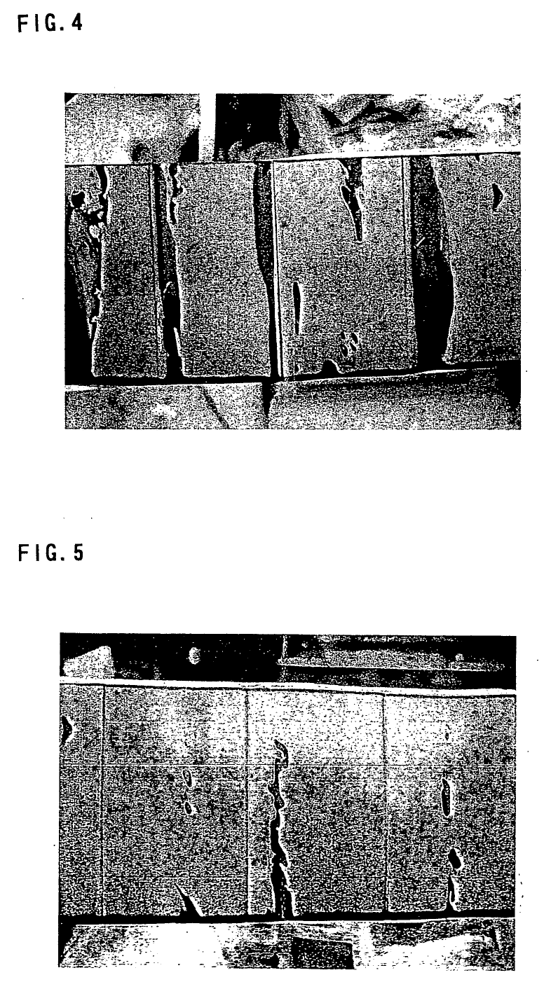

The condition of the negative electrode after storage test was observed for each of the battery A1 of Example 1 and the battery X2 of Comparative Example 2. Specifically, after the storage test, each battery was charged at a constant current of 650 mA to a voltage of 4.2 V, further charged at a constant voltage of 4.2 V to a current value of 32 mA and then disassembled to remove the negative electrode for observation. FIGS. 2 and 3 both show the negative electrode of Example 1. FIG. 2 shows its top side and FIG. 3 shows its back side. FIGS. 4 and 5 both show the negative electrode of Comparative Example 2. FIG. 4 shows its top side and FIG. 5 shows its back side.

As can be clearly seen from the comparison between FIG. 2-5, the battery of Comparative Example 2, charged after experience of a large expansion in the storage test, is observed to have portions colored in gold (white in the drawings) that include a number of black portions left unreacted. Formation of such unreacted black portions is believed due to air bubbles that resulted from a gas generated during storage, resided between the electrodes and disturbed a reaction at electrode portions in contact therewith.

On the other hand, no unreacted portion is observed in the charged negative electrode of the battery of Example 1 in accordance with this invention. This demonstrates that the charge reaction took place homogeneously.

As can be appreciated from the foregoing, the mixing of lithium cobaltate in the lithium transition metal complex oxide, in accordance with this invention, reduces gas generation during storage, allows the charge reaction to take place homogeneously and prevents property deterioration of batteries after high-temperature storage.

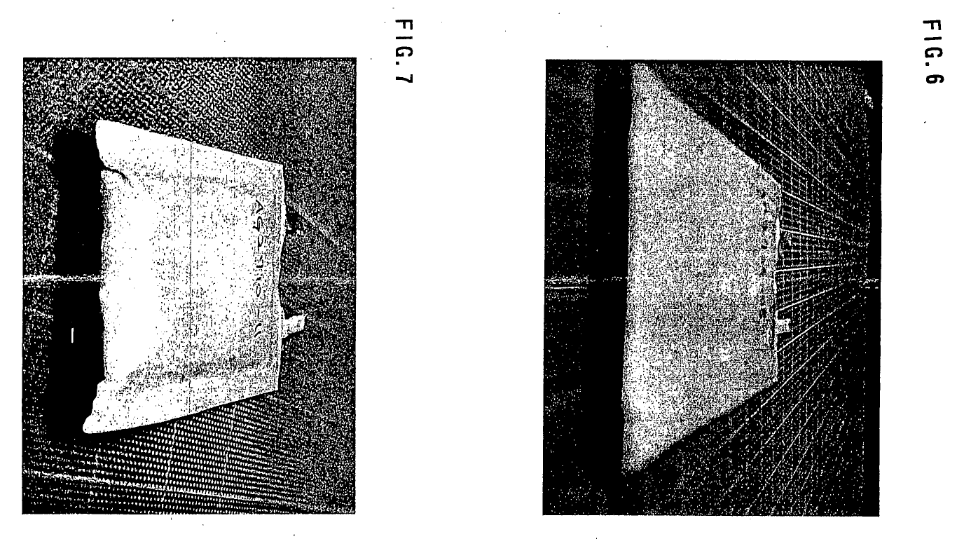

FIG. 6 is a photograph which shows the battery of Comparative Example 2 before the storage test. FIG. 7 is a photograph which shows the battery of Comparative Example 2 after the storage test. As can be clearly seen from the comparison between FIGS. 6 and 7, the storage test caused expansion of the outer casing of the battery.

### EXAMPLE 3

The procedure of Example 1 was followed, except that LiMn_{0.33}Ni_{0.33}Co_{0.34}O₂ and LiCoO₂ in the weight ratio of 90:10 were mixed in an Ishikawa automated mortar to prepare the positive active material, to construct a lithium secondary battery A3. The constructed battery had an initial thickness of 3.66 mm.

### EXAMPLE 4

The procedure of Example 3 was followed, except that 70 weight % of LiMn_{0.33}Ni_{0.33}Co_{0.34}O₂ was replaced by LiMn_{0.33}Ni_{0.33}Co_{0.34}O₂ containing 7,900 ppm fluorine, to construct a lithium secondary battery A4. The constructed battery had an initial thickness of 3.71 mm.

The lithium transition metal complex oxide containing fluorine was prepared according to the following procedure.

(Preparation of Fluorine-Containing Lithium Transition Metal Complex Oxide)

LiOH, LiF and a coprecipitated hydroxide, represented by Mn_{0.33}Ni_{0.33}Co_{0.34}(OH)₂, were mixed in an Ishikawa automated mortar such that a molar ratio of Li to all transition metals was brought to 1:1, and then heat treated under an ambient atmosphere at 1,000° C. for 20 hours, so that a fluorine content of the lithium transition metal complex oxide was brought to about 8,000 ppm. After the heat treatment, the resultant was ground to obtain the lithium transition metal complex oxide containing fluorine and represented by LiMn_{0.33}Ni_{0.33}Co_{0.34}O₂. The resulting lithium transition metal complex oxide had a BET specific surface area of 0.33 m²/g.

The obtained lithium transition metal complex oxide, measuring 10 mg, was added to 100 ml of a 20 wt. % aqueous solution of hydrochloric acid and then heated at about 80° C. for 3 hours so that the lithium transition metal complex oxide was dissolved therein. The amount of fluorine (F) in the resulting solution was measured by a fluorine ion meter. As a result, the amount of fluorine contained in the lithium transition metal complex oxide was found to be 7,900 ppm.

(Construction of Battery Using Fluorine-Containing Lithium Transition Metal Complex Oxide as Sole Positive Active Material)

The procedure of Example 1 was followed, except that the above-prepared, fluorine-containing lithium transition metal complex oxide was used as the sole positive active material, to construct a lithium secondary battery X3. The constructed battery had an initial thickness of 3.69 mm. Expansion of this battery after high-temperature storage was measured in the same manner as described above and determined to be 0.52 mm.

(Evaluation of High-Temperature Storage Properties)

The high-temperature storage properties for each of the above-constructed lithium secondary batteries A3 and A4 were evaluated in the same manner as in Example 1. The measured and estimated values for expansion of each battery after high-temperature storage are shown in Table 3. The estimated value for expansion of the battery A4 after high-temperature storage was calculated from the measured values for expansion of the batteries X1, X2 and X3 after high-temperature storage. In Table 4, the discharge capacity before storage, retained capacity, retention rate, restored capacity and restoration rate are listed.

TABLE 3

| | | LiMn_{0.33}Ni_{0.33}Co_{0.34}O₂ | Battery Expansion after | |
|---|---|---|---|---|
| | | Content of Positive | High-Temperature Storage | |
| | | Active Material | Measured | Estimated |
| | Battery | (parts by weight) | Value (mm) | Value (mm) |
| Ex. 3 | A3 | 90 | 1.92 (52.5%) | 2.58 (70.5%) |
| Ex. 4 | A4 | 90 | 0.92 (24.8%) | 1.12 (30.2%) |

TABLE 4

| | | | | | Restored |
|---|---|---|---|---|---|
| | | LiMn_{0.33}Ni_{0.33}Co_{0.34}O₂ | | Retained Capacity | Capacity |
| | | Content of Positive | Discharged | (mAh) | (mAh) |
| | | Active Material | Capacity before | (Retention | (Restoration |
| | Battery | (parts by weight) | Storage (mAh) | Rate) | Rate) |
| Ex. 3 | A3 | 90 | 648.6 | 531.1 | 547.6 |
| | | | | (81.9%) | (84.4%) |
| Ex. 4 | A4 | 90 | 657.4 | 586.8 | 603.2 |
| | | | | (89.3%) | (91.7%) |

As can be clearly seen from the results shown in Tables 3 and 4, the inclusion of fluorine in the lithium transition metal complex oxide further prevents battery expansion and further improves high-temperature storage properties.

In Example 4, the weight ratio of the lithium transition metal complex oxide to lithium cobaltate was set at 9:1. However, the weight ratio, if set at 1:1, further improves a gas generation reducing effect, further prevents battery expansion and further improves high-temperature storage properties.

The use of a mixture containing the lithium transition metal complex oxide and lithium cobaltate as the positive electrode material, in accordance with this invention, reduces a gas generated when the battery is stored in the charged state at high temperatures, prevents battery expansion and reduces deterioration of battery properties by high-temperature storage.

Reference Experiment 1

In this experiment, a lithium secondary battery was constructed using an aluminum alloy can made using a 0.5 mm thick, aluminum alloy plate (Al—Mn—Mg alloy, JIS A 3005, proof stress 14.8 kgf/mm²) as an outer casing. In the case where only the lithium transition metal complex oxide was used as the positive active material, the use of such an outer casing was confirmed to cause the battery to expand after the storage test.

(Construction of Reference Battery 1)

The above-described outer casing comprising an aluminum alloy can was used. Only LiCoO₂ was used as the positive active material. The battery was built in a 6.5 mm thick, 3.4 cm wide and 5.0 cm long size. Otherwise, the procedure of Example 1 was followed to construct a lithium secondary battery Y1. The constructed battery had an initial thickness of 6.01 mm.

(Construction of Reference Battery 2)

The above-described outer casing comprising an aluminum alloy can was used. Only LiMn_{0.33}Ni_{0.33}Co_{0.34}O₂ was used as the positive active material. The battery was built in a 6.5 mm thick, 3.4 cm wide and 5.0 cm long size. Otherwise, the procedure of Example 1 was followed to construct a lithium secondary battery Y2. The constructed battery had an initial thickness of 6.04 mm.

(Evaluation of Battery Expansion after High-Temperature Storage)

Each of the above-constructed batteries was charged at room temperature at a constant current of 950 mA to a voltage of 4.2 V, further charged at a constant voltage of 4.2 V to a current value of 20 mA, and then stored in a constant temperature bath at 85° C. for 3 hours. The battery after storage was cooled at room temperature for 1 hour and then measured for battery thickness. The battery expansion after high-temperature storage was evaluated in the same manner as in Experiment 1. The evaluation results are shown in Table 5.

TABLE 5

| | | LiMn_{0.33}Ni_{0.33}Co_{0.34}O₂ | Battery Expansion |
|---|---|---|---|
| | | Content of Positive | after |
| | | Active Material | High-Temperature |
| | Battery | (parts by weight) | Storage |
| Reference | Y1 | 0 | 0.25 (4.2%) |
| Battery 1 | | | |
| Reference | Y2 | 100 | 1.42 (23.5%) |
| Battery 2 | | | |

As apparent from Table 5, the battery Y2 using the lithium transition metal complex oxide alone, after high-temperature storage, shows a very large battery expansion of 1.42 mm. This demonstrates that the outer casing, even if comprising a 0.5 mm thick aluminum alloy can, experiences deformation due to an increase of an internal pressure. Where such an outer casing is used, application of this invention, i.e., mixing of lithium cobaltate in the lithium transition metal complex oxide is expected to reduce gas generation during high-temperature storage and result in the marked reduction of battery expansion.

Reference Experiment 2

For the purpose of investigating a main cause of storage deterioration of the battery of Comparative Example 2, the battery was disassembled after the storage test and the recovered positive electrode was subjected to the following experiment.

(Electrode Performance Test)

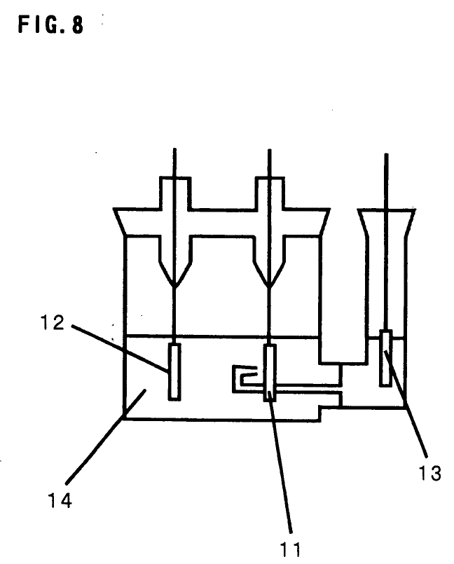

The three-electrode beaker cell shown in FIG. 8 was constructed using the above-recovered positive electrode as a working electrode, metallic lithium for both the counter electrode and reference electrode, and an electrolyte solution prepared by dissolving 1 mole/liter of LiPF₆ in a mixed solvent (EC/EMC=3/7 (volume ratio)) containing ethylene carbonate (EC) and ethyl methyl carbonate (EMC). As shown in FIG. 8, the working electrode 11, the counter electrode 12 and the reference electrode 13 were immersed in the electrolyte solution 14.

The constructed cell was charged at a current density of 0.75 mA/cm² to 4.3 V (vs. Li/Li⁺) and then discharged at a current density of 0.75 mA/cm² to 2.75 V (vs. Li/Li⁺) to determine a capacity per gram (mAh/g) of positive active material. Next, the constructed cell was charged at a current density of 0.75 mA/cm² to 4.3 V (vs. Li/Li⁺) and then discharged at a current density of 3.0 mA/cm² to 2.75 V (vs. Li/Li⁺) to determine a capacity per gram (mAh/g) of positive active material. Also, when the cell was discharged at a current density of 0.75 mA/cm², an average electrode potential was calculated from the following equation. The positive electrode before the storage test was also subjected to the same test to compare performances of the positive electrode before and after the storage test.
[Average electrode potential (V vs. Li/Li⁺)]=[gravimetric energy density (mWh/g) during discharge]÷[capacity per weight (mAh/g)]

The results of the charge-discharge test at the discharge current density of 0.75 mA/cm² are listed in Table 6. The results of the charge-discharge test at the discharge current density of 3.0 mA/cm² are listed in Table 7.

TABLE 6

| Positive | Discharge | Energy | Average Electrode |
|---|---|---|---|
| Electrode of | Capacity | Density | Potential |
| Comp. Ex. 2 | (mAh/g) | (mWh/g) | (V vs. Li/Li⁺) |
| Before | 158.3 | 602.8 | 3.807 |
| Storage Test | | | |
| After | 155.6 | 589.3 | 3.787 |
| Storage Test | | | |

TABLE 7

| Positive | Discharge | Ratio of Discharge |
|---|---|---|
| Electrode of | Capacity | Capacities 3.0 mA/cm² |
| Comp. Ex. 2 | (mAh/g) | and 0.75 mA/cm² |
| Before | 145.8 | 92.1 |
| Storage Test | | |
| After Storage | 143.5 | 92.2 |
| Test | | |

As apparent from Tables 6 and 7, no appreciable difference in performance characteristics exists between the positive electrode before and after storage. It is thus believed that no deterioration occurs in the positive active material or positive electrode by high-temperature storage.

(Measurement of XRD Pattern After and Before Storage)

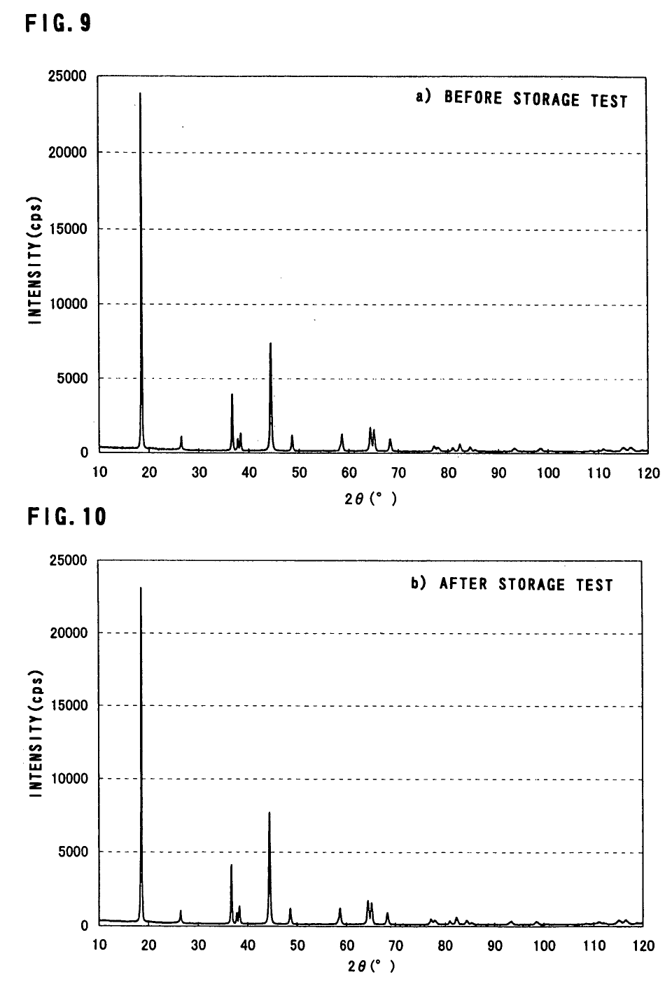

X-ray diffraction (XRD) measurement using a Cu-Kαray as a radiation source was performed for the positive electrode (in the discharged state) recovered after storage, as described above, and the positive electrode before the storage test. The measurement results are shown in FIGS. 9 and 10. FIG. 9 shows an XRD pattern before the storage test. FIG. 10 shows an XRD pattern after the storage test. As apparent from the comparison between FIGS. 9 and 10, the XRD pattern little changes between before and after the storage test. It is therefore believed that the structure of the positive active material remains unchanged between before and after the storage test.

From the foregoing, it is believed that the storage deterioration of the battery is based neither on a structural change of the positive active material nor on electrode deterioration, but is attributed to a gas generated during storage that stays between electrodes and renders a charge-discharge reaction heterogeneous. In accordance with the present invention, gas generation during storage can thus be reduced to thereby prevent property deterioration of the battery while stored.

1. In a sealed, nonaqueous electrolyte secondary battery having an outer casing which deforms as an internal pressure of the battery increases, said nonaqueous electrolyte secondary battery being characterized as using a material capable of storing and releasing lithium as the negative electrode material, and a mixture containing a lithium transition metal complex oxide and lithium cobaltate as the positive electrode material, said lithium transition metal complex oxide containing Ni and Mn as transition metals, having a layered structure and containing fluorine.

2. The nonaqueous electrolyte secondary battery as recited in claim 1, characterized in that said internal pressure increase is caused by a gas generated in the battery while stored.

3. The nonaqueous electrolyte secondary battery as recited in claim 1, characterized in that said outer casing is formed at least partly of an aluminum alloy or laminated aluminum film with a thickness of 0.5 mm or below.

4. In a nonaqueous electrolyte secondary battery which has a rectangular shape and includes positive and negative electrodes each having a rectangular electrode face, said nonaqueous electrolyte secondary battery being characterized as using a material capable of storing and releasing lithium as the negative electrode material, and a mixture containing a lithium transition metal complex oxide and lithium cobaltate as the positive electrode material, said lithium transition metal complex oxide containing Ni and Mn as transition metals, having a layered structure and containing fluorine.

5. A sealed, nonaqueous electrolyte secondary battery using a lithium transition metal complex oxide containing Ni and Mn as transition metals and having a layered structure, as the positive electrode material, and having an outer casing which, when only said lithium transition metal complex oxide is used as the positive electrode material, is caused to expand by a gas generated in the battery while stored; said nonaqueous electrolyte secondary battery being characterized in that a mixture of said lithium transition metal complex oxide containing fluorine and lithium cobaltate is used as the positive electrode material.

6. The nonaqueous electrolyte secondary battery as recited in claim 1, characterized in that said lithium transition metal complex oxide is represented by the formula LiₐMnₓNi_{y}Co_{z}O₂ (wherein a, x, y and z are numerical values which satisfy the relationships 0≦a≦1.2, x+y+z=1, x>0, y>0, and z>0).

7. The nonaqueous electrolyte secondary battery as recited in claim 1, characterized in that said lithium transition metal complex oxide contains nickel and manganese in substantially the same amount.

8. The nonaqueous electrolyte secondary battery as recited in claim 1, characterized in that said lithium transition metal complex oxide has a mean particle diameter of 20 μm or below.

9. The nonaqueous electrolyte secondary battery as recited in claim 1, characterized in that said lithium cobaltate has a mean particle diameter of 10 μm or below.

10. The nonaqueous electrolyte secondary battery as recited in claim 1, characterized in that said lithium transition metal complex oxide and lithium cobaltate are mixed together before they are mixed with a binder to fabricate the positive electrode.

11. (canceled)

12. A method for reducing a gas generated in a nonaqueous electrolyte secondary battery, while stored in the charged state, which uses a lithium transition metal complex oxide containing Ni and Mn as transition metals and having a layered structure, as the positive electrode material; said method being characterized in that lithium cobaltate is mixed in said lithium transition metal complex oxide containing fluorine.

13. (canceled)

14. The nonaqueous electrolyte secondary battery as recited in claim 4, characterized in that said lithium transition metal complex oxide is represented by the formula LiₐMnₓNi_{y}Co_{z}O₂ (wherein a, x, y and z are numerical values which satisfy the relationships 0≦a≦1.2, x+y+z=1, x>0, y>0, and z≧0).

15. The nonaqueous electrolyte secondary battery as recited in claim 5, characterized in that said lithium transition metal complex oxide is represented by the formula LiₐMnₓNi_{y}Co_{z}O₂ (wherein a, x, y and z are numerical values which satisfy the relationships 0≦a≦1.2, x+y+z=1, x>0, y>0, and z≧0).

16. The nonaqueous electrolyte secondary battery as recited in claim 4, characterized in that said lithium transition metal complex oxide contains nickel and manganese in substantially the same amount.

17. The nonaqueous electrolyte secondary battery as recited in claim 5, characterized in that said lithium transition metal complex oxide contains nickel and manganese in substantially the same amount.

18. The nonaqueous electrolyte secondary battery as recited in claim 4, characterized in that said lithium transition metal complex oxide has a mean particle diameter of 20 μm or below.

19. The nonaqueous electrolyte secondary battery as recited in claim 5, characterized in that said lithium transition metal complex oxide has a mean particle diameter of 20 μm or below.

20. The nonaqueous electrolyte secondary battery as recited in claim 4, characterized in that said lithium cobaltate has a mean particle diameter of 10 μm or below.

21. The nonaqueous electrolyte secondary battery as recited in claim 5, characterized in that said lithium cobaltate has a mean particle diameter of 10 μm or below.

22. The nonaqueous electrolyte secondary battery as recited in claim 4, characterized in that said lithium transition metal complex oxide and lithium cobaltate are mixed together before they are mixed with a binder to fabricate the positive electrode.

23. The nonaqueous electrolyte secondary battery as recited in claim 5, characterized in that said lithium transition metal complex oxide and lithium cobaltate are mixed together before they are mixed with a binder to fabricate the positive electrode.
